(19) United States
(12) Patent Application Publication
(10) Pub. No.: US 2026/0367598 A1
(43) Pub. Date: Nov. 19, 2026

(54) ADVANCED USER ASSISTANCE FOR DESCRIBING SIGNAL CONNECTIONS OF HARDWARE VARIANTS WITH MOTOR CONTROL UNIT PINS ON A MOTOR CONTROL INVERTER BOARD

(71) Applicant: STMicroelectronics International N.V., Geneva (CH)

(72) Inventors: Francesco Roberto D'AMICO, Gravina di Catania (IT); Alessandro Massimiliano CORSARO, Mascalucia (IT); Carmelo Marcello PALANO, Acicatena (IT)

(73) Assignee: STMicroelectronics International N.V., Geneva (CH)

(21) Appl. No.: 19/373,508

(22) Filed: Oct. 29, 2025

Related U.S. Application Data
(60) Provisional application No. 63/807,460, filed on May 16, 2025.

(51) Int. Cl. G05B 19/042; H02P 23/00

(52) U.S. Cl. CPC G05B 19/042; G05B 2219/25257; H02P 23/0004

(57) ABSTRACT

A feature of a motor control inverter board is determined. A hardware variant that implements the feature is selected. A signal of the hardware variant is selected. Microcontroller unit (MCU) information is obtained. One or more intellectual property cores (IPs) of the MCU that are usable to interface with the hardware variant are determined based on the signal and the MCU information. An IP of the one or more IPs is assigned to the signal. A configuration data structure associated with the motor control inverter board may be automatically updated based on the assignment of the IP to the signal.

### BACKGROUND

### Technical Field

The present application is generally directed to assisting a user with routing signal connections of a microcontroller unit with components of a motor control inverter board.

### BRIEF SUMMARY

In some embodiments, a method includes: presenting, via a graphical user interface (GUI), a list of features that can be implemented using a motor control inverter board that includes a microcontroller unit (MCU); receiving, via the GUI, selection of a feature of the list of features to be implemented by the motor control inverter board; determining a hardware variant to be used to implement the selected feature; identifying a signal of the hardware variant to connect to the MCU; identifying, from the MCU information and based on the signal, an intellectual property core (IP) capable of interfacing with the signal; identifying, from the MCU information and based on the IP, an MCU pin corresponding to the IP; assigning the MCU pin to interface with the signal; and updating a motor control inverter board configuration data structure to reflect assigning the MCU pin to interface with the signal.

In some embodiments, a system includes: one or more processors; and one or more memories collectively configured to store instructions executable by the one or more processors to perform actions to: present, via a graphical user interface (GUI), a list of features that can be implemented using a motor control inverter board that includes a microcontroller unit (MCU); receive, via the GUI, selection of a feature of the list of features to be implemented by the motor control inverter board; determine a hardware variant to be used to implement the selected feature; identify a signal of the hardware variant to connect to the MCU; identify, from the MCU information and based on the signal, an intellectual property core (IP) capable of interfacing with the signal; identify, from the MCU information and based on the IP, an MCU pin corresponding to the IP; assign the MCU pin to interface with the signal; update a motor control inverter board configuration data structure to reflect assigning the MCU pin to interface with the signal.

In some embodiments, one or more non-transitory computer-readable media collectively store instructions executable by one or more processors to perform actions, the actions including: obtaining microcontroller unit (MCU) information; presenting, via a graphical user interface (GUI), a list of features that can be implemented using a motor control inverter board that includes the MCU; receiving, via the GUI, selection of a feature of the list of features to be implemented by the motor control inverter board; determining a hardware variant to be used to implement the selected feature; identifying a signal of the hardware variant to connect to the MCU; identifying, from the MCU information and based on the signal, an intellectual property core (IP) capable of interfacing with the signal; identifying, from the MCU information and based on the IP, an MCU pin corresponding to the IP; assigning the MCU pin to interface with the signal; updating a motor control inverter board configuration data structure to reflect assigning the MCU pin to interface with the signal.

### BRIEF DESCRIPTION OF THE SEVERAL VIEWS OF THE DRAWINGS

FIG. 1 is a sequence diagram illustrating a process for assisting a user with routing signal connections of a microcontroller unit with components of a motor control inverter board in some embodiments.

FIG. 2 is a context diagram showing data flow for assisting a user with routing signal connections of a microcontroller unit with components of a motor control inverter board in some embodiments.

FIG. 3 is a circuit diagram illustrating two hardware variants for implementing a current sensing feature in some embodiments.

FIG. 4 illustrates a hardware variant for implementing a current sensing feature and a user interface showing microcontroller unit pins usable to interface with the hardware variant in some embodiments.

FIG. 5 illustrates a semantic validation feature for assisting a user with routing signal connections of a microcontroller unit with components of a motor control inverter board in some embodiments.

FIGS. 6, 7, 8, 9 and 10 are table diagrams illustrating mappings from signals of hardware variants implementing a feature of a motor control inverter board to microcontroller unit pin functionalities.

FIG. 11 is a system diagram illustrating computing systems for implementing embodiments described herein.

FIG. 12 is a logical flow diagram illustrating an example process for assisting a user with routing signal connections of a microcontroller unit with components of a motor control inverter board in some embodiments.

### DETAILED DESCRIPTION

Creating inverter boards for motor control applications is typically a difficult process. A primary difficulty is deciding how to connect various components of the inverter board to a microcontroller unit (MCU). Often, the MCU is an integrated circuit that contains intellectual property cores (“IPs”) configured to implement functions of the MCU. In one non-limiting example, an IP of an MCU is configured to read an analog signal and convert it into a digital signal (e.g., analog to digital conversion or “ADC”). Continuing the example, the ADC IP may be associated with one or more pins of the MCU that are used to obtain the analog signal to be converted into the digital signal.

An inverter board for motor control applications may include various components, signal lines from which are to be routed to appropriate pins of the MCU. Typically, only a subset of the MCU pins are usable to interface with a given component. In one non-limiting example, only a small subset of MCU pins are connected to IPs that perform analog to digital conversion. It is often unclear which pins of the MCU to connect to each component of the inverter board. Correctly routing components of the inverter board to the microcontroller unit requires knowledge of which intellectual property cores (“IPs”) of the MCU should be used to interface with each component, and how IPs of the MCU correspond to the MCU pins. Accordingly, users designing inverter boards refer to dense specification sheets of the MCU to decide how to connect components of the inverter board. This process is tedious, time-consuming, and error-prone. Dependencies between signals and other rules or design limitations further complicate this process. Once the user decides how to route components with the MCU, the user typically modifies a configuration data structure such as a JavaScript Object Notation (JSON) document to reflect the selected routing. This is also a difficult and error-prone process that often relies on the user correctly filling out fields of the configuration data structure to reflect their choices.

Techniques disclosed herein enable users who want to create a new inverter board for motor control applications to focus their efforts on what they want to achieve. Starting from knowledge of hardware variants used to implement features of the inverter board and signals associated with the hardware variants, techniques disclosed herein automatically provide users with the IPs to which each signal can be connected through the microcontroller unit (MCU) pins. Using information about the MCU to be mounted on the board and, knowing the type of hardware variant signal to be connected, an appropriate list of IPs to use for the signal is determined. Based on this IP information, MCU pins appropriate for implementing the relevant feature of the inverter board are automatically filtered and proposed to the user or automatically assigned. For example, given a hardware variant used to implement the feature of current sensing on the inverter board, IPs of the MCU that are usable to interface with the hardware variant are filtered and provided to the user via a graphical user interface (“GUI”). The user can interact with the GUI to further refine the proposed choices of IP types and consequently the pins. Moreover, in some embodiments, semantic validation is performed to ensure that assignments of the IPs to the signals does not violate a connection rule associated with a signal. In one non-limiting example where a connection rules specifies that two or more signals are to be provided as inputs for the same IP, once a pin is selected to interface with a first signal of the two or more signals, semantic validation is performed to ensure the same pin is selected for the other signals of the two or more signal. In some embodiments, selecting a pin for use with the signal automatically modifies the configuration data structure to reflect the selection. This further reduces error and enables the user to focus on important board design decisions. Using techniques disclosed herein, speed and accuracy of generating or updating the configuration data structure is improved.

While embodiments are discussed in terms of the case of determining how to route signals of components of a motor control inverter board to pins of a microcontroller unit, the disclosure is not so limited. In various embodiments, techniques disclosed herein are used to determine how to route signals of any board to pins of any integrated circuit. In one non-limiting example, techniques disclosed herein are used to automatically recommend or perform assignment of component signals to pins of an automotive microcontroller.

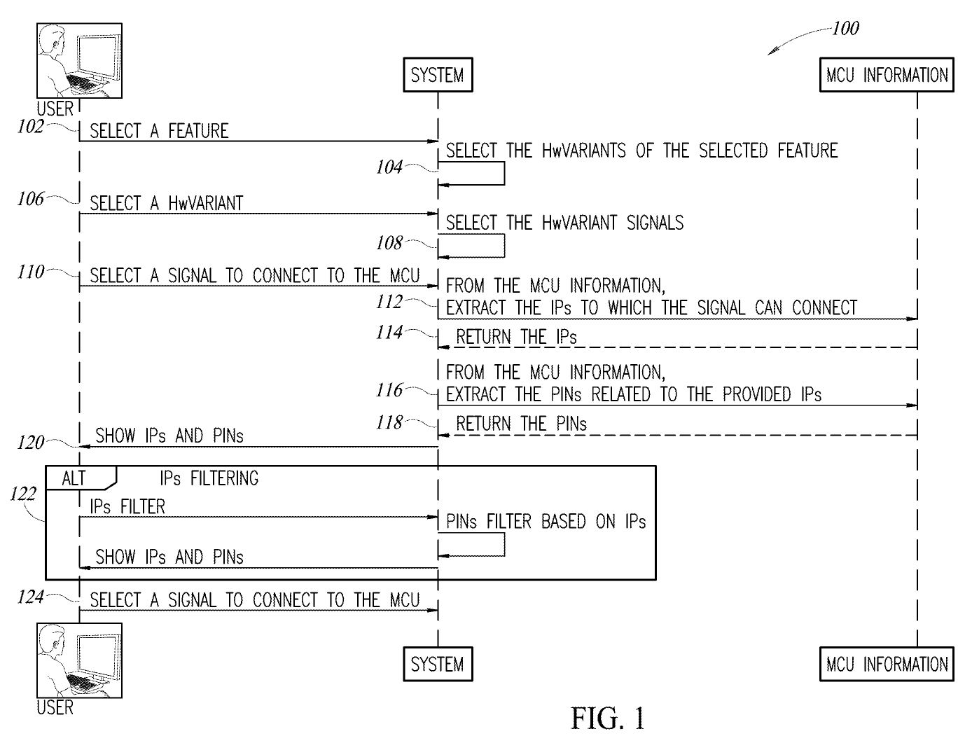

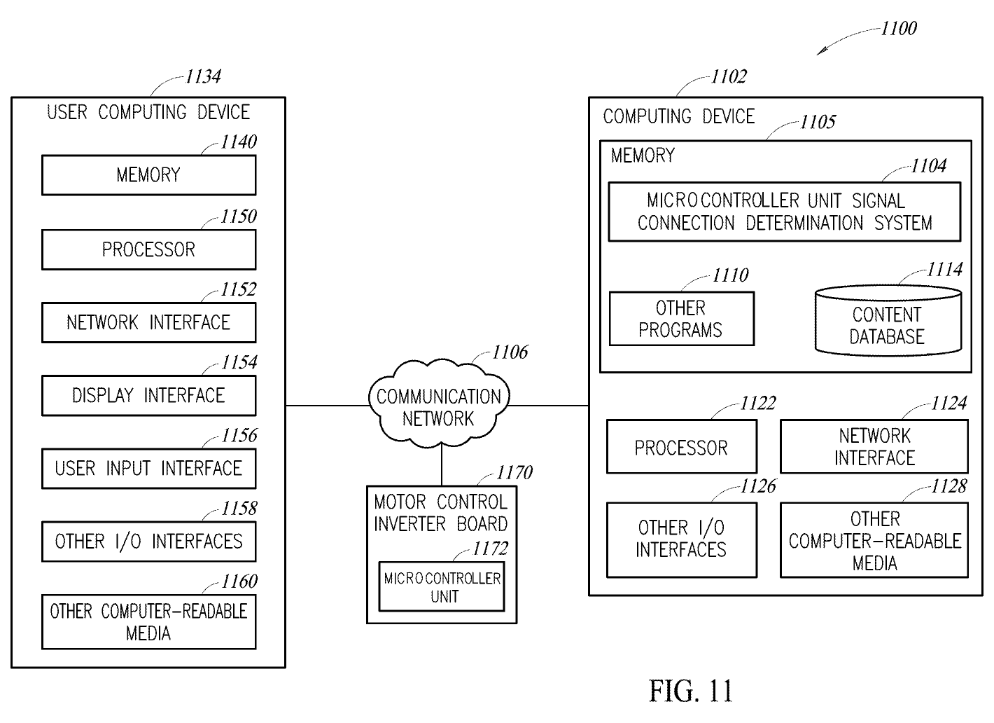

FIG. 1 is a sequence diagram illustrating a process 100 for assisting a user with routing signal connections of a microcontroller unit with components of a motor control inverter board in some embodiments. In various embodiments, process 100 is implemented using system 1100 of FIG. 11. While process 100 illustrates making a single pin-signal assignment for ease of discussion, in various embodiments process 100 is performed iteratively to make multiple pin-signal assignments.

At 102, a feature to be implemented on the motor control inverter board is selected. In various embodiments, the feature is speed or position sensing, phase voltage generation, current sensing, overcurrent protection, current limiter, bus voltage sensing, brake, inrush current limiter, phase voltage sensing, temperature sensing, drive protection, button, electronic speed control, serial port communication, potentiometer, etc. In some embodiments, the feature is selected based on user input received using a graphical user interface. In some embodiments, the feature is automatically selected from a set of features to be implemented by the motor control inverter board.

In some embodiments, the feature is selected based on a flexibility of assigning a signal of the feature to a pin of the MCU, such as a count of pins of MCU that are usable to interface with the signal of the feature. In one non-limiting example where a feature of phase voltage generation is to be implemented on the motor control inverter board, only one pin of the MCU is capable of interfacing with the feature. To prevent the one pin from being allocated to other signals, the feature of phase voltage generation may be selected for assignment before other signals to which pins can be more flexibly assigned.

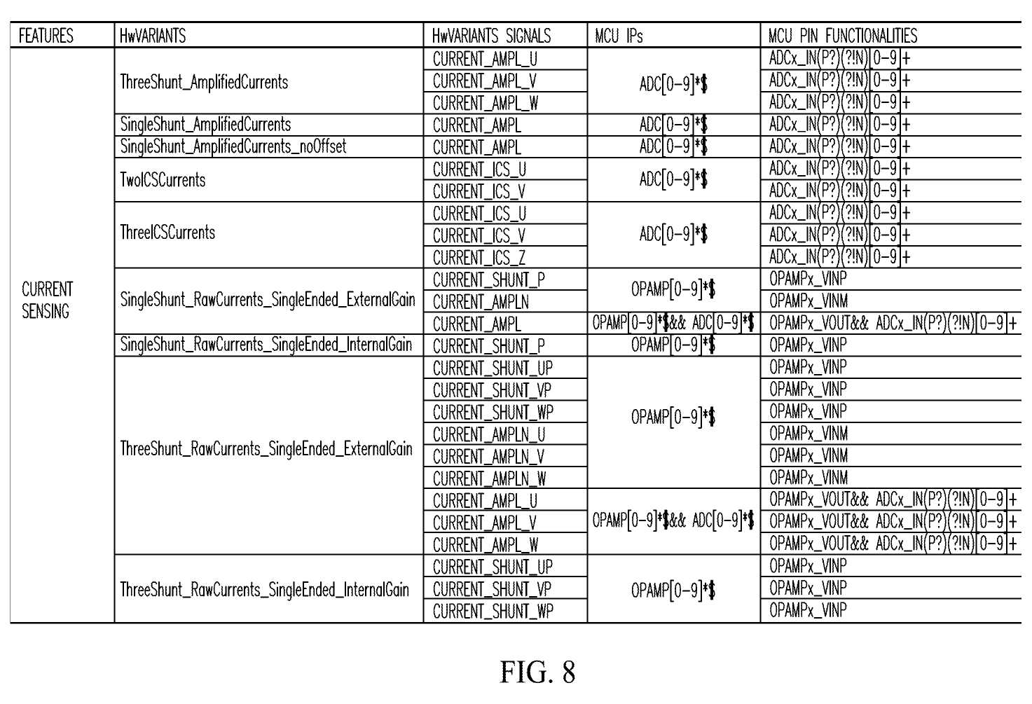

At 104, hardware variants of the selected feature are obtained. As discussed herein, a hardware variant is a specific hardware configuration that implements the selected feature. In one non-limiting example, the feature of current sensing can be implemented using various hardware configurations such as a three shunt amplified currents hardware variant, a single shunt amplified currents hardware variant, etc. Non-limiting examples of hardware variants that implement the feature of current sensing are shown in FIG. 8.

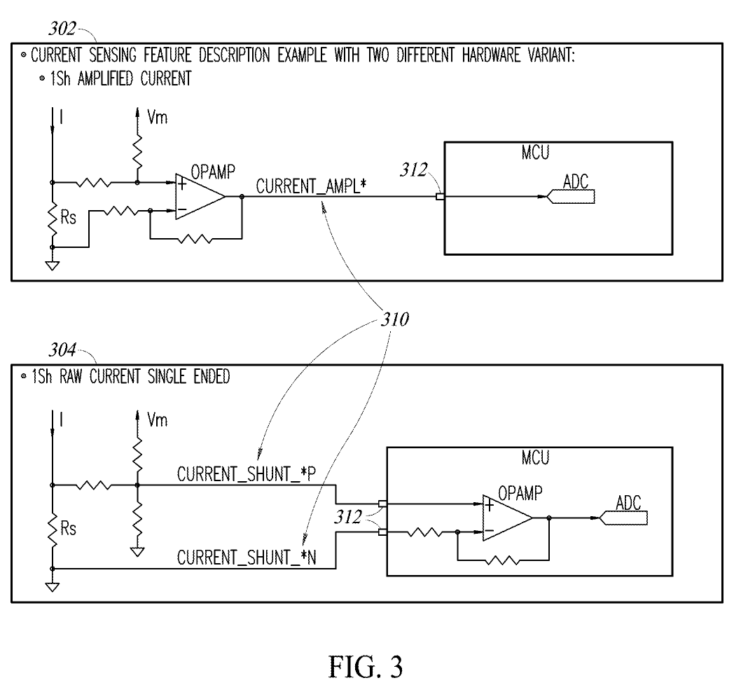

At 106, a hardware variant to be used to implement the selected feature is selected. In some embodiments, the hardware variants are provided to the user for selection through a GUI. In one non-limiting example, a graphical user interface (GUI) including hardware variants implementing a current sensing feature is presented to the user. The user selects a hardware variant to be used to implement the selected feature (e.g., current sensing) via the graphical user interface. The GUI may be employed to present other options to the user and receive other user selections. Hardware variants are described in further detail at least with respect to FIG. 3.

At 108, signals associated with the hardware variant are determined. In some embodiments, the signals associated with the hardware variant include a signal produced using the hardware variant that is to be provided to a microcontroller unit (MCU). In one non-limiting example, a hardware variant for current sensing provides a signal that indicates a current to the MCU. In another non-limiting example, a hardware variant implementing a drive protection feature provides a drive protection trigger signal to the MCU.

In some embodiments, the signals associated with the hardware variant include a signal produced using the MCU that is to be provided to the hardware variant. In one non-limiting example, a phase voltage generation hardware variant receives a signal indicating a pulse-width modulation to be used in phase voltage generation.

In some embodiments, the signals associated with the hardware variant include any combination of signals provided to the MCU from the hardware variant and signals provided to the hardware variant using the MCU. In one non-limiting example, a current limiter hardware variant provides a first signal HF_ETR to the MCU, and receives a second signal PWM_REF from the MCU. In some embodiments, the signals are provided to the user for selection (e.g., via a GUI).

At 110, a signal is selected to connect to the microcontroller unit (MCU). In some embodiments, the signal is selected based on user input received via a graphical user interface. In some embodiments, the signal is automatically selected.

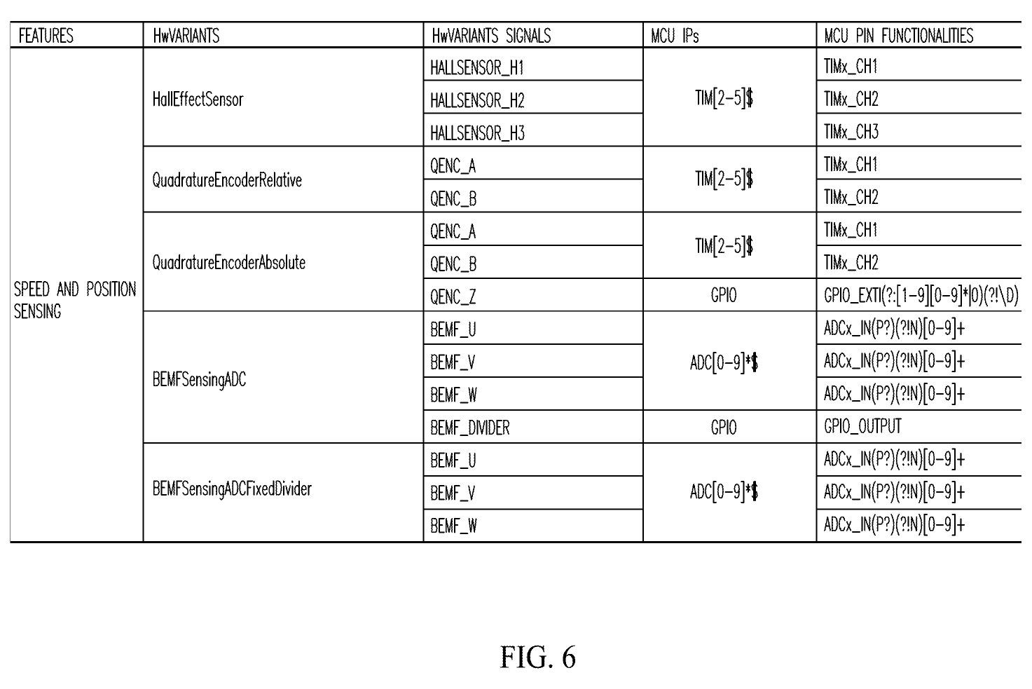

At 112, MCU information is obtained, and intellectual property cores (IPs) of the MCU usable to interface with the signal are determined. In some embodiments, the MCU information includes mappings from signals to MCU IPs usable to interface with the signals. FIGS. 6-10 show various non-limiting examples of MCU information including mappings from hardware variant signals to MCU IPs and MCU pin functionalities corresponding to the MCU IPs. In some embodiments, determining the IP cores usable to interface with signals includes retrieving MCU IPs that correspond to the signal. Referring to FIG. 6, in one non-limiting example, given a signal HALLSENSOR_H1, MCU IPs TIM(2-5)$ are usable to interface with the signal.

At 114, the determined IPs are returned. In some embodiments, returning the determined IPs includes causing the determined IPs to be displayed using a graphical user interface.

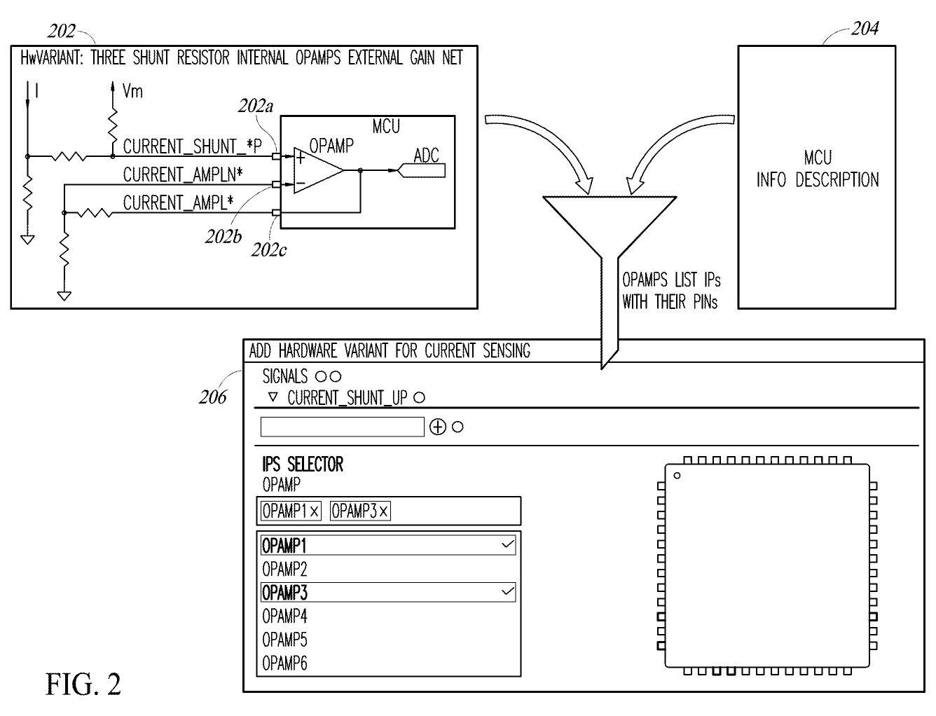

At 116, pins of the MCU related to the determined IPs are identified. Referring again to FIG. 6, in one non-limiting example given determined IPs of TIM(2-5)$, MCU pin functionalities TIMx_CH1, TIMx_CH2, and TIMx_CH3 are identified, and pins corresponding to these functionalities are identified. In various embodiments, the pins of the MCU related to the determined IPs include a pin that interfaces with an input of a determined IP, a pin that interfaces with an output of a determined IP, or any combination thereof. Referring to FIG. 2, in one non-limiting example, pins 202a and 202b interface with an input of an operational amplifier, and pin 202c interfaces with an output of the operational amplifier.

At 118, the pins are returned. In some embodiments, returning the pins includes causing the pins to be displayed using a graphical user interface.

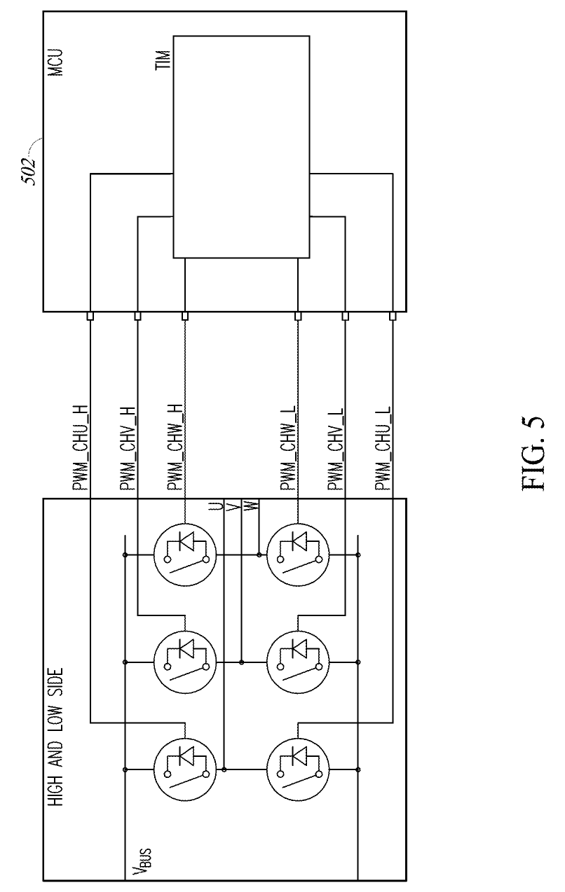

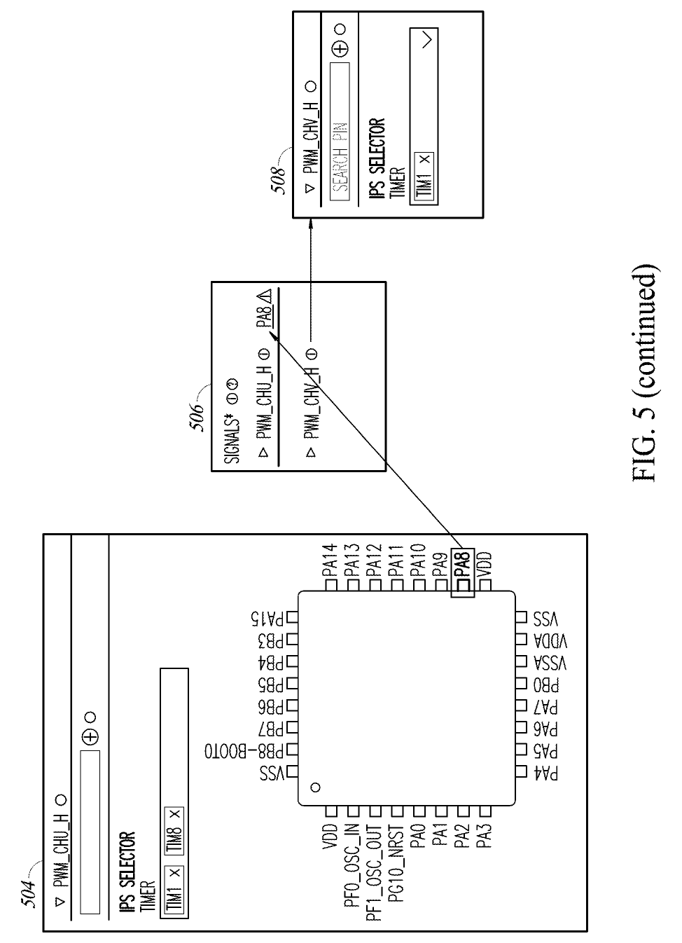

At 120, the IPs and pins are provided to the user for selection (e.g., via a GUI). In various embodiments, the pins are filtered based on the IPs at 122. In some embodiments, the pins are filtered based on semantic validation as described at least with respect to FIG. 5. At 124, the user selects a pin to connect to the signal. While not shown in FIG. 1, in various embodiments, a definition of the inverter board, such as a structured document, is automatically updated to reflect assignment of the pin to the signal.

In some embodiments, the MCU or another component of the inverter board is programmed based on the assignment of the pin to the signal. In one non-limiting example, the MCU is a programmable integrated circuit such as a field-programmable gate array that is programmed based on the assignment of the pin to the signal. In some embodiments, the inverter board is configured based on the assignment of the pin to the signal. In some embodiments, a layout of the inverter board is determined based on the assignment of the pin to the signal.

While FIG. 1 illustrates actions as taken by the user or the system, the disclosure is not so limited. In some embodiments, one or more actions shown as being taken by the user in FIG. 1 are automatically taken by the system. In one non-limiting example, the system automatically selects the feature at 102, selects the hardware variant at 106, selects the signal to connect to the MCU at 110, selects the pin to connect to the signal, or any combination thereof. In various embodiments, the system automatically performs process 100 for a plurality of features. In one non-limiting example, a plurality of features to be implemented by the inverter board is obtained, and process 100 is iteratively performed such that each signal associated with the plurality of features to be implemented is automatically assigned to appropriate pins of the MCU.

The acts shown in FIG. 1 and as described herein may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

FIG. 2 is a context diagram showing data flow for assisting a user with routing signal connections of a microcontroller unit with components of a motor control inverter board in some embodiments. In some embodiments, hardware variant information 202 and microcontroller unit information 204 are used to display a list of IPs and corresponding pins using graphical user interface (GUI) 206. In some embodiments, GUI 206 receives selection of an IP in the list of IPs to assign to the signal. In the example shown in FIG. 2, the list of IPs includes several IPs that are usable to interface with the signal “CURRENT_SHUNT_UP” such as “OPAMP1,” “OPAMP2,” etc. Based on user input received via GUI 206, the IPs “OPAMP1” and “OPAMP2” are selected to be assigned to the signal, as indicated by the bold lettering, selection boxes around the selected IPs, and inclusion of the selected IPs in a selection box. As shown in FIG. 2, hardware variant information 202 is for a three shunt resistor internal op-amps external gain net hardware variant implementing a current sense feature. Signals associated with the hardware variant are determined and mapped to IPs of the MCU based on MCU information 204. The list of IPs and corresponding pins shown in GUI 206 includes IPs, pins, or both of the MCU that are usable to interface with the signal associated with the hardware variant. In some embodiments, GUI 206 visually indicates pins of the MCU that correspond to the list of IPs, the selected IPs, or both, using a schematic of the MCU. In the example shown in FIG. 2, the corresponding pins of the MCU are visually indicated by increased line weight relative to other pins of the MCU.

FIG. 3 is a circuit diagram illustrating two hardware variants for implementing a current sensing feature in some embodiments. In various embodiments, there are multiple ways to implement a function of the motor control inverter board in hardware (i.e., there are multiple hardware variants). Signals 310 indicate signals of the hardware variants that are to interface with the MCU. MCU pins 312 indicate pins of the MCU that are used to interface with the signals 310. First hardware variant 302 is a 1Sh Amplified Current hardware variant that can be used to implement the feature of current sensing. Second hardware variant 304 is a 1Sh Raw Current Single Ended hardware variant that can be used to implement the feature of current sensing. As shown, first hardware variant 302 uses one signal CURRENT_AMPL*, which is to interface with an analog to digital converter (ADC) of the MCU. Second hardware variant 304 uses two signals, CURRENT_SHUNT_*P and CURRENT_SHUNT_*N, which is to interface with an op-amp and ADC of the MCU. Accordingly, despite two hardware variants implementing the same feature of current sensing, the two hardware variants are to be connected to different pins of the MCU. Techniques disclosed herein enable suitable pins of the MCU to be automatically proposed to the user for use with a hardware variant, reducing the need for the user to have knowledge of the MCU and signals of the particular hardware variant to be used.

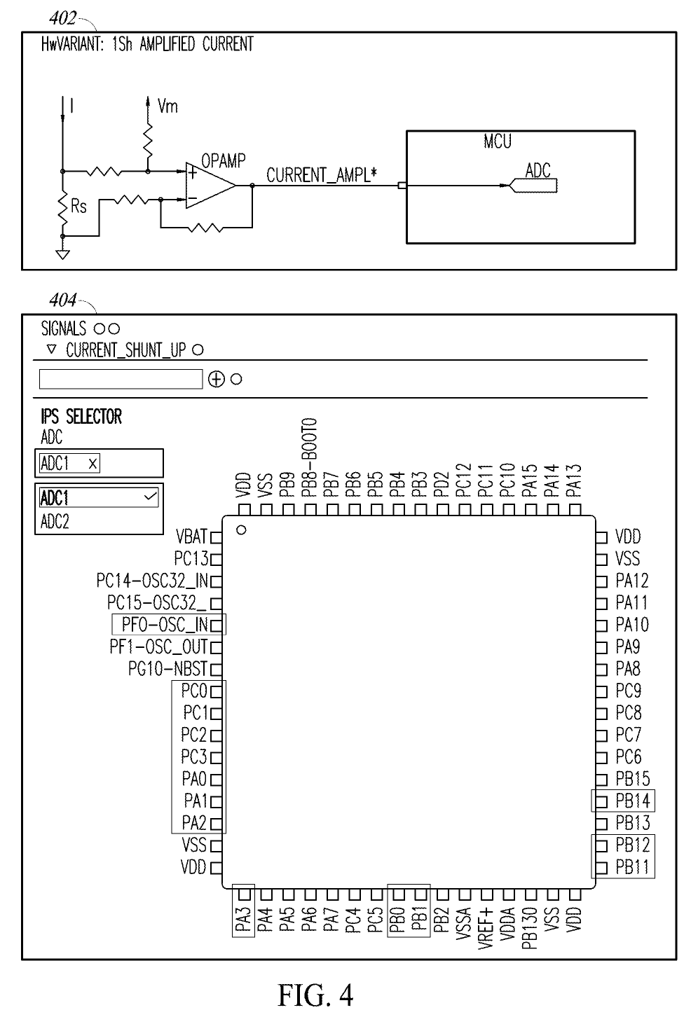

FIG. 4 illustrates a hardware variant for implementing a current sensing feature and a user interface showing microcontroller unit pins usable to interface with the hardware variant in some embodiments. Hardware variant 402 implements a current sensing feature. Graphical user interface (GUI) 404 shows an example result of process 100 of FIG. 1, whereby pins of the MCU usable to interface with hardware variant 402 are automatically indicated. As shown in GUI 404, pins usable to interface with the signal “CURRENT_SHUNT_UP” pins are indicated by boxes around the pin names on the MCU schematic. As shown in GUI 404, the signal CURRENT_AMPL associated with hardware variant 402 is selected. A drop-down menu for selecting an IP of the MCU that corresponds to the signal is provided, and MCU pins corresponding to the IPs usable to interface with the are visually indicated on an illustration of the MCU by boxes around the MCU pins.

FIG. 5 illustrates graphical user interfaces showing a semantic validation feature for assisting a user with routing signal connections of a microcontroller unit with components of a motor control inverter board in some embodiments. FIG. 5 includes hardware variant 502, MCU visualization GUI 504, signal assignment GUI 506, and IP selector GUI 508.

As discussed herein, in various embodiments, multiple IPs of an MCU and pins corresponding to the IPS can be used to interface with a signal of a hardware variant. Referring back to FIG. 4, when considered in isolation, the signal CURRENT_AMPL of hardware variant 402 can interface with each of the indicated pins shown on the MCU visualization. However, in practice, the IPs/MCU pins usable to interface with a signal of a hardware variant are further limited based on relationships to be maintained between other signals of the hardware variant, other signals of hardware variants implementing other features, etc. Often, not every IP or MCU pin capable of interfacing with a signal considered in isolation can be used to interface with the signal when considering other signals that are to interface with the MCU. Again referring to FIG. 4, while numerous pins are highlighted on the MCU visualization as being usable to interface with signal CURRENT_AMPL, pins usable to interface with signal CURRENT_AMPL, while also accommodating one or more other signals, may be significantly reduced.

“Semantic validation” refers to processes used to ensure that an assignment of an IP/MCU pin to a signal is compatible with other signals to interface with the MCU or other requirements. In various embodiments, semantic validation compares assignments of signals to IPs or MCU pins to one or more rules associated with the signals to ensure that the assignments are compatible when considered in context of other signals to interface with the MCU.

In various embodiments, a signal of a hardware variant is associated with one or more rules that constrain how the signal is to interact with other signals or components. Semantic validation enables assignments or potential assignments of IPs or MCU pins to be checked against rules associated with signals, helping ensure that a selected assignment of IPs to signals does not violate the rules.

In one non-limiting example, a signal “PWM_CHV_H” of hardware variant 502, when considered in isolation, is capable of interfacing with any one of several timer IPs of an MCU. But a rule associated with hardware variant 502 specifies that all signals of hardware variant 502 are to interface with a same IP of the MCU. Accordingly, only IPs capable of interfacing with each signal associated with hardware variant 502 are to be used to interface with the signal “PWM_CHV_H”. Because hardware variant 502 includes six signals, only timer IPs of the MCU capable of interfacing with six or more signals are to be used to interface with signal “PWM_CHV_H”. Such IPs, including TIM1 And TIM8, are indicated on MCU visualization GUI 504. In some embodiments, display of the usable pins is based on filtering out pins that do not satisfy the rule. For example, pins that correspond to IPs that cannot support each signal of hardware variant 502 (e.g., the IPs cannot support interfacing with six signals) may be filtered out.

Because TIM1 is already assigned to signal “PWM_CHU_H” of hardware variant 502, as shown in signal assignment GUI 506, and because each signal of hardware variant 502 is to interface with the same IP of the MCU, IP selector GUI 508 shows TIM1 as selectable to assign to signal “PWM_CHV_H” of hardware variant 502. In this example, to ensure that each signal of hardware variant 502 is assigned to the same IP, TIM1 is to be displayed in IP selector GUI 508 for each signal of hardware variant 502.

While FIG. 5 describes semantic validation with respect to a rule whereby each signal of hardware variant 502 is to be connected to a same IP of the MCU, the disclosure is not so limited. In various embodiments, semantic validation is performed to accommodate any rule associated with assignment of signals of a hardware variant to IPs or pins of the MCU.

In various embodiments, semantic validation is performed to ensure compatibility between multiple signal-pin assignments within a single hardware variant. The example described above with respect to hardware variant 502 is one non-limiting example of performing semantic validation to ensure compatibility between signal-pin assignments within a single hardware variant.

In another non-limiting example, a feature of current sensing involves using an operational amplifier (“op-amp”) of the MCU to amplify a current signal, and providing the amplified current signal to an analog to digital converter (“ADC”) of the MCU, which converts the amplified current signal into a digital signal to be further processed by the MCU. This example MCU configuration is described with respect to hardware variant information 202 of FIG. 2. As shown in hardware variant information 202, a first pin 202a and a second pin 202b of the MCU are electrically connected to the inputs of the op amp, and a third pin 202c of the MCU is electrically connected between the output of the op amp (“OP_AMP VOUT”) and the input of the ADC (“ADC_IN”).

Three hardware variants for implementing the feature of current sensing are described below with respect to the example MCU configuration depicted in hardware variant information 202 of FIG. 2, whereby the MCU includes an op amp, the output of which is electrically connected to an analog to digital converter (ADC). The MCU includes a first pin 202a that is electrically connected to a non-inverting input of the op map, a second pin 202b that is electrically connected to an inverting input of the op amp, and a third pin 202c that is electrically connected between the output of the op amp (“OPAMP_VOUT”) and the input of the ADC (“ADC_IN”). In the three following example hardware variants, signals may vary from those shown in hardware variant information 202 (e.g., “CURRENT_SHUNT_*P”, “CURRENT_AMPLN*”, and “CURRENT_AMPL*”). For each of the three example hardware variants discussed below, one or more rules limit how signal-pin assignments are to be made within each respective hardware variant.

In some embodiments, according to a hardware variant rule for a first hardware variant implementing the feature of current sensing “SingleShunt_RawCurrents_SingleEnded_ExternalGain”, a “CURRENT_AMPL*” signal is to be connected to the third pin 202c that is electrically connected between the op amp and the ADC. Accordingly, in various embodiments where the first hardware variant is selected, semantic validation ensures that the “CURRENT_AMPL*” signal is connected to the third pin 202c.

In some embodiments, according to a hardware variant rule for a second hardware variant implementing the feature of current sensing “TreeShunt_RawCurrents_SingleEnded_ExternalGain”, a “CURRENT_AMPL_U” signal, a “CURRENT_AMPL_V” signal, and a “CURRENT_AMPL_W” signal are each to be connected to the third pin 202c that is electrically connected between the output of the op amp and the input of the ADC. Accordingly, in some embodiments where the “CURRENT_AMPL_U” signal is assigned to the third pin 202c, semantic validation is performed to ensure that the “CURRENT_AMPL_V” signal, and the “CURRENT_AMPL_W” signal are also assigned to the third pin 202c.

In some embodiments, according to a hardware variant rule for a third hardware variant implementing the feature of current sensing “TreeShunt_RawCurrents_Differential_ExternalGain”, a “CURRENT_AMPL_U” signal, a “CURRENT_AMPL_V” signal, and a “CURRENT_AMPL_W” signal are each to be connected to the third pin 202c that is electrically connected between the output of the op amp and the input of the ADC in the MCU. Accordingly, in some embodiments where the “CURRENT_AMPL_W” signal is assigned the third pin 202c, semantic validation is performed to ensure that the “CURRENT_AMPL_V” signal, and the “CURRENT_AMPL_U” signal are also assigned to the third pin 202c.

In various embodiments, semantic validation is performed to ensure that a pin communicating with a specified configuration of IPs is used to interface with a signal. In one non-limiting example, the signal “CURRENT_AMPL” is used as input to identify types of IPs to be used, such as an op-amp, ADC, etc. In the three current sensing examples above, the IPs to be used are an op-amp and an ADC. In some embodiments, the MCU information is used as input to filter MCU pins that connect to a specified configuration of IPs, such as MCU pins that connect between “OPAMP_VOUT” and “ADC_IN” channels of an op-amp and an ADC, respectively.

In some embodiments, semantic validation proactively enforces a hardware variant rule, such as by only displaying the third pin 202c as a connection option for the “CURRENT_AMPL” signal using a GUI. In some embodiments, semantic validation enforces the hardware variant rule retroactively based on detecting that a selected pin-signal assignment does not satisfy the hardware variant rule. In one non-limiting example, based on detecting that a pin-signal assignment violates a hardware variant rule, a warning that identifies the hardware variant rule and a pin assignment that violates the rule is provided to the user through a graphical user interface. In some embodiments, based on detecting that a pin-signal assignment violates a hardware variant rule, the pin-signal assignment is automatically changed to an assignment that does not violate the rule.

In some embodiments, semantic validation causes a signal-pin assignment to be retroactively reassigned to accommodate a select signal. In one non-limiting example, the select signal is to interface exclusively with a pin. However, each pin that would otherwise be suitable to interface with the signal is already assigned to interface with a different signal. Therefore, based on the current signal-pin assignment, there is no suitable pin to which the select signal can be assigned. To accommodate the select signal, in this example, a determination is made whether it is possible to reassign one or more signals such that a suitable pin can be exclusively assigned to the select signal. In various embodiments where such an assignment is possible, the reassignment is made automatically, or an option to make the reassignment is provided to the user via a graphical user interface.

In some embodiments, signals to interface with the MCU are iteratively assigned, with semantic validation being performed periodically, such as after each assignment. In one non-limiting example, input specifying that a first signal is to interface with the MCU is received. Several different ADCs of the MCU, such as ADC1, ADC2, ADC3, or ADC4 are each capable of receiving the first signal. Accordingly, each of these assignment options are provided to the user. Input assigning the first signal to ADC3 is received. Then, input specifying that a second signal is to interface with the MCU is received. Rules corresponding to the second signal specify that the second signal is (1) to interface with either ADC1 or ADC2; and (2) to interface with a same ADC as the first signal. Because the first signal is already assigned to ADC3; however, no assignment of the second signal can be made that satisfies both rules. In some embodiments, based on detecting that no assignment of the second signal can be made that satisfies each rule, the first signal is automatically reassigned to an IP to enable an assignment of the second signal. Continuing the example, the first signal is reassigned to ADC1 or ADC2 such that the second signal can be assigned (1) either ADC1 or ADC2; and (2) to a same IP as the first signal in accordance with the rules.

In various embodiments, semantic validation is performed proactively to ensure compatibility of interdependent connections between two or more hardware variants. In one non-limiting example of proactive semantic validation, a first signal of a first hardware variant and a second signal of a second hardware variant are to interface with the MCU. Rules corresponding to the second signal specify that the second signal is (1) to interface with one of IPs ADC1 or ADC2; and (2) to interface with a same ADC as the first signal. A rule corresponding to the first signal specifies that the first signal is to interface with one of IPs ADC1, ADC2, ADC3, or ADC4. In this example, no pin assignment has yet been made for the first signal or the second signal. When considered in isolation, it is acceptable to interface the first signal with ADC1, ADC2, ADC3, or ADC4.

However, because the second signal is to interface with ADC1 or ADC2, and is also to interface with a same ADC as the first signal, when considered in light of the rules corresponding to the second signal, the first signal is to interface only with ADC1 or ADC2. Thus, in some embodiments, the user is provided with an option to assign the first signal to ADC1 or ADC2, instead of to ADC1, ADC2, ADC3, or ADC4, despite no assignment having been previously made for the second signal. By performing semantic validation across a plurality of signals before providing IP options for a signal, IP assignments that are incompatible with the plurality of signals can be proactively filtered out before IP assignments are made, which may prevent or lessen later revisions to assignments.

In another non-limiting example of proactive semantic validation, an over-current protection feature, a drive protection feature, and a current limiter feature each depend on a phase voltage generation feature. A signal “OC_TRIGGER” of the over-current protection feature is to interface with a same timer that is used for the phase voltage generation. A “DP_TRIGGER” signal of the drive protection feature is to interface with the same timer that is used for phase voltage generation. An “HF_ETR” signal of the current limiter feature is to interface with the same timer that is used for the phase voltage generation feature. In some embodiments, assignment of the phase voltage generation feature to a pin corresponding to a first timer causes the first timer to be automatically assigned to interface with the “OC_TRIGGER” signal, the “DP_TRIGGER” signal, or the “HF_ETR” signal. In some embodiments, assignment of any one of the “OC_TRIGGER” signal, “DP_TRIGGER” signal, “HF_ETR” signal, or phase voltage generation signal to a first timer causes one or more of the other signals to be automatically assigned to the first timer.

In some embodiments, a hardware variant rule specifies that a signal of the hardware variant is to be exclusively connected to a pin of the MCU, to, for example, reduce interference from other signals. In one non-limiting example, assignment of the signal to the pin may modify subsequent IP selection interfaces such as IP selector GUI 508 so the pin or IPs associated with the pin are not selectable for use with other signals.

In some embodiments, a hardware variant rule specifies that a pin of the MCU is to be non-exclusively assigned to a signal. In the second and third hardware variants implementing current sensing described above, for example, the third pin 202c non-exclusively interfaces with three signals: a “CURRENT_AMPL_U” signal, a “CURRENT_AMPL_V” signal, and a “CURRENT_AMPL_W” signal.

While semantic validation is described as being performed with respect to rules corresponding to hardware variants, the disclosure is not so limited. In various embodiments, semantic validation is performed using rules corresponding to signals, features, etc. that are not necessarily limited to a single hardware variant, or any combination thereof. In one non-limiting example, a signal rule specifies that the signal is to interface with an ADC, regardless of which hardware variant the signal appears in. In another non-limiting example, a feature rule specifies that any hardware variant implementing a first feature is to interface with an IP that also interfaces with a hardware variant implementing a second feature.

FIGS. 6, 7, 8, 9 and 10 are table diagrams illustrating example mappings from signals of hardware variants implementing a feature of a motor control inverter board to microcontroller unit pin functionalities. FIG. 6 shows example hardware variant signals associated with speed and position sensing, organized by hardware variant. MCU pin functionalities that correspond to each hardware variant signal are also shown, organized by MCU IP. For example, the hardware variant “HallEffectSensor” includes hardware variant signals “HALLSENSOR_H1,” “HALLSENSOR_H2,” and “HALLSENSOR_H3,” which correspond to the MCU IPs “TIM[2-5]$”, which in turn correspond to MCU pin functionalities “TIMx_CH1,” “TIMx_CH2,” and “TIMx_CH3.” Accordingly, given the hardware variant “HallEffectSensor,” signals are to be routed to MCU pin functionalities “TIMx_CH1,” “TIMx_CH2,” and “TIMx_CH3.” Using the relationships shown in FIGS. 6-10, compatible IPs or pin functionalities of the MCU can be determined for the shown hardware variants.

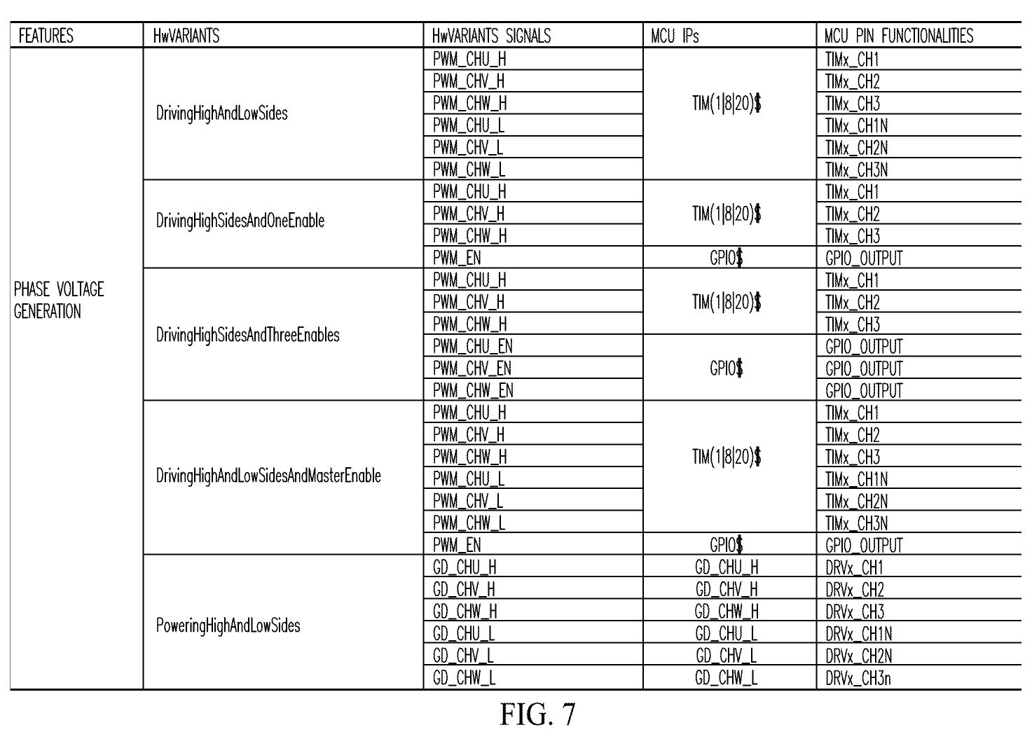

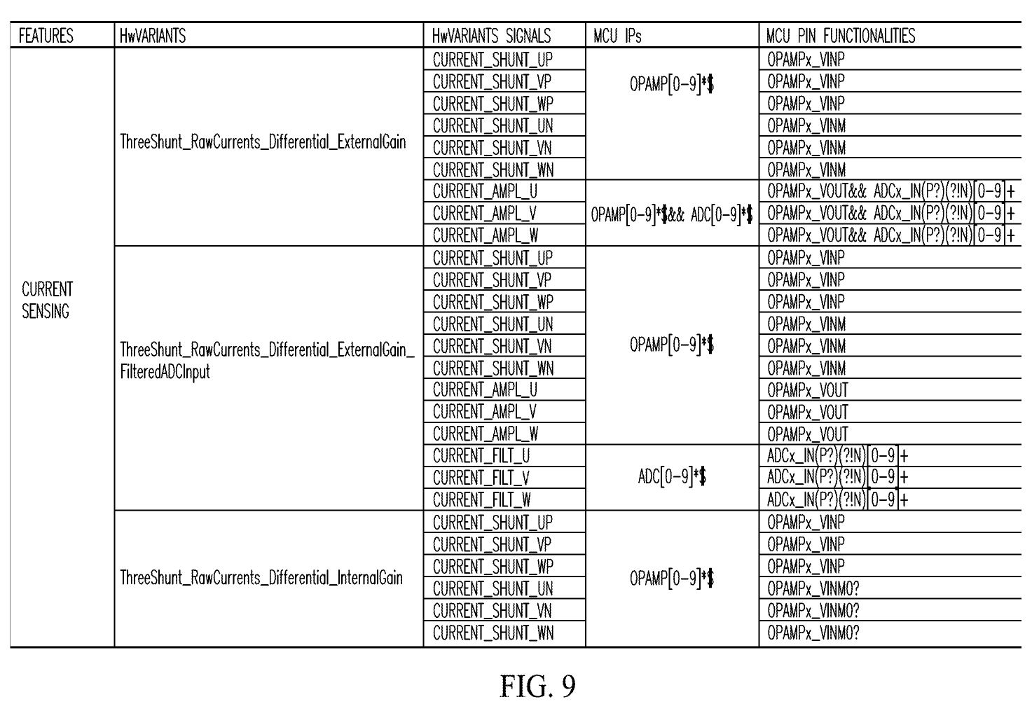

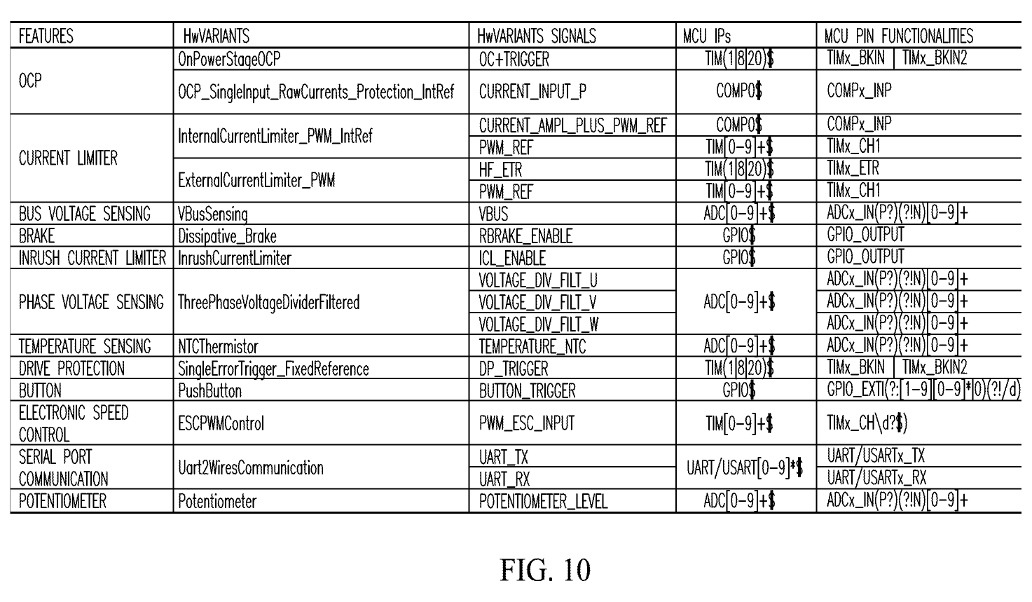

FIG. 7 shows example hardware variant signals and corresponding MCU pin functionalities associated with the feature of phase voltage generation. FIG. 8 shows example hardware variant signals and corresponding MCU pin functionalities for the feature of current sensing. FIG. 9 shows additional hardware variant signals and corresponding MCU pin functionalities for the feature of current sensing. FIG. 10 shows hardware variant signals and corresponding MCU pin functionalities for the features of overcurrent protection, current limiter, bus voltage sensing, brake, inrush current limiter, phase voltage sensing, temperature sensing, drive protection, button, electronic speed control, serial port communication, and potentiometer.

While relationships for various features, hardware variants, hardware variant signals, MCU IPs, and MCU pin functionalities of motor control inverter boards are shown in FIGS. 6-10, the disclosure is not so limited. In various embodiments, relationships between any feature of a motor control inverter board and MCU pin functionalities are obtained and used to automatically recommend an IP or MCU pin for use with a signal of a hardware variant implementing the feature.

FIG. 11 is a system diagram illustrating computing system 1100 for implementing embodiments described herein. In various embodiments, system 1100 includes computing device 1102, user computing device 1134, and motor control inverter board, which communicate via communication network 1106. In various embodiments, communication network 1106 includes a wired connection, a wireless connection, or any combination thereof.

As described herein, computing device 1102 is a computing device or system that can perform functionality described herein for providing advanced user assistance for describing signal connections of hardware variants with microcontroller unit pins on a motor control inverter board. One or more special purpose computing systems may be used to implement computing device 1102. Accordingly, various embodiments described herein may be implemented in specialized software, hardware, firmware, or in some combination thereof. In various embodiments, computing device 1102 includes memory 1105, processor 1122, network interface 1124, input/output (I/O) interfaces 1126, and other computer-readable media 1128.

Processor 1122 includes one or more processors, one or more processing units, programmable logic, circuitry, or one or more other computing components that are configured to perform embodiments described herein or to execute computer instructions to perform embodiments described herein. In some embodiments, a processor system computing device 102 may include a single processor 1122 that operates individually to perform actions. In other embodiments, a processor system of computing device 1102 may include a plurality of processors 1122 that operate to collectively perform actions, such that one or more processors 1122 may operate to perform some, but not all, of such actions.

In various embodiments, memory 1105 includes one or more types of non-volatile or volatile storage technologies. Examples of memory 1105 include, but are not limited to, flash memory, hard disk drives, optical drives, solid-state drives, various types of random-access memory (“RAM”), various types of read-only memory (“ROM”), other computer-readable storage media (also referred to as processor-readable storage media), or other memory technologies, or any combination thereof. Memory 1105 may be utilized to store information, including computer-readable instructions that are utilized by a processor system of one or more processors 1122 to perform actions, including at least some embodiments described herein.

In some embodiments, memory 1105 stores microcontroller unit signal connection determination system 1104, which is configured to determine MCU pins or IPs usable to interface with a hardware variant, as described herein.

In some embodiments, memory 1105 stores other programs 1110 such as operating systems, applications, etc. In some embodiments, memory 1105 stores content database 1114, which includes, for example, mappings of hardware variant signals to MCU pin functionalities as shown with respect to FIGS. 6-10, a configuration data structure that includes information about a motor control inverter board, hardware variants or components of the board, assignments of signals associated with the hardware variants or components of the board to pins or IPs of the MCU, rules associated with hardware variants that are used for semantic validation, etc.

Network interface 1124 is configured to communicate with other computing devices, such as to provide user device 1134 with IPs to assign to a signal of a hardware variant, to receive user input selecting an IP to assign to the signal of the hardware variant, etc. In some embodiments, I/O interfaces 1126 include interfaces for various input or output devices, such as USB interfaces, physical buttons, keyboards, haptic interfaces, tactile interfaces, etc. Other computer-readable media 1128 may include other types of stationary or removable computer-readable media, such as removable flash drives, external hard drives, etc.

In various embodiments, features of user computing device such as memory 1140, processor 1150, network interface 1152, or other I/O interfaces, other computer-readable media 1160 are similar to like features described with respect to computing device 1102. In some embodiments, display interface 1154 is configured to display a graphical user interface such as GUI 404 of FIG. 4. In some embodiments, user input interface 1156 is configured to obtain user input such as user input selecting an IP to assign to a signal.

While the microcontroller unit signal connection determination system 1104 is shown as being implemented using computing device 1102, in various embodiments, microcontroller unit signal connection determination system 1104 is implemented in part or in full using user computing device 1134.

Motor control inverter board 1170 includes microcontroller unit 1172. In various embodiments, motor control inverter board 1170 includes one or more hardware variants that implement one or more features of motor control inverter board 1170. In some embodiments, microcontroller unit 1172 or other components of motor control inverter board are programmed or configured according to an assignment of one or more pins or IPs to a signal determined using microcontroller unit signal connection determination system 1104. In some embodiments, a layout of motor control inverter board 1170 is determined using microcontroller unit signal connection determination system 1104. In some embodiments, motor control inverter board 1170 is manufactured using microcontroller unit signal connection determination system 1104, such as a motor control inverter board configuration data structure. In various embodiments, a location on motor control inverter board 1170 of a hardware variant, trace, or other component is determined using microcontroller unit signal connection determination system 1104.

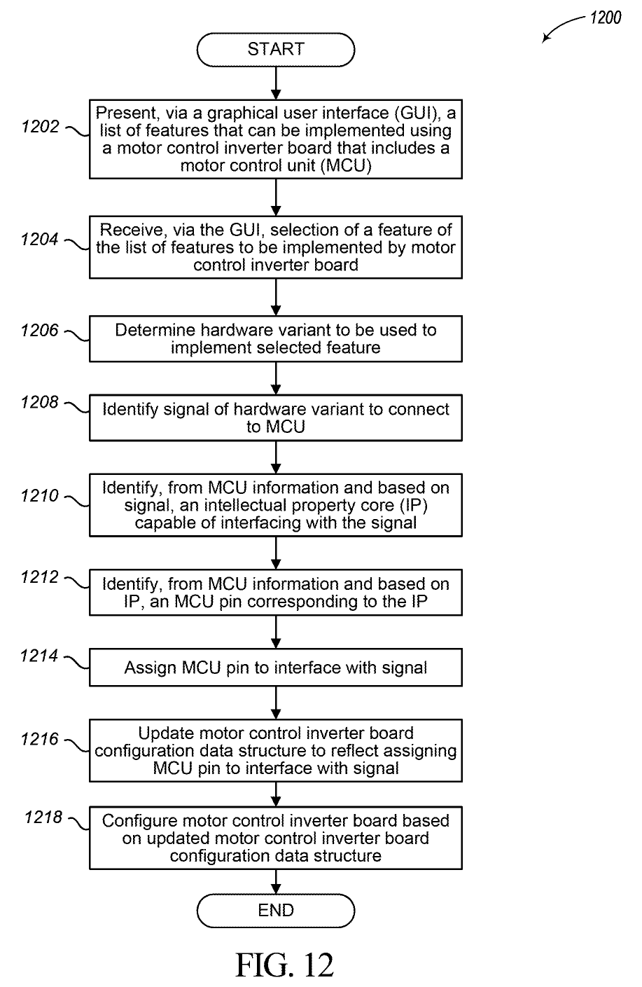

FIG. 12 is a logical flow diagram illustrating an example process 1200 for assisting a user with routing signal connections of a microcontroller unit with components of a motor control inverter board in some embodiments.

At 1202, a list of features that can be implemented using a motor control inverter board that includes a microcontroller unit (MCU) is presented via a graphical user interface.

At 1204, selection of a feature of the list of features to be implemented by the motor control inverter board is received via the GUI.

At 1206, a hardware variant to be used to implement the selected feature is determined.

At 1208, a signal of the hardware variant to connect to the MCU is identified.

At 1210, an intellectual property core (IP) capable of interfacing with the signal is identified from MCU information based on the signal.

At 1212, an MCU pin corresponding to the IP is identified from MCU information based on the IP.

At 1214, the MCU pin is assigned to interface with the signal.

At 1216, a motor control inverter board configuration data structure is updated to reflect assigning the MCU pin to interface with the signal.

At 1218, in some embodiments, the motor control inverter board is configured based on the updated motor control inverter board configuration data structure. After 1218, process 1200 ends.

The following is a summary of the claims as originally filed.

In various embodiments, a method includes: presenting, via a graphical user interface (GUI), a list of features that can be implemented using a motor control inverter board that includes a microcontroller unit (MCU); receiving, via the GUI, selection of a feature of the list of features to be implemented by the motor control inverter board; determining a hardware variant to be used to implement the selected feature; identifying a signal of the hardware variant to connect to the MCU; identifying, from the MCU information and based on the signal, an intellectual property core (IP) capable of interfacing with the signal; identifying, from the MCU information and based on the IP, an MCU pin corresponding to the IP; assigning the MCU pin to interface with the signal; and updating a motor control inverter board configuration data structure to reflect assigning the MCU pin to interface with the signal.

In some embodiments, the method includes: performing semantic validation to verify that the IP is capable of interfacing with the signal in accordance with one or more connection rules.

In some embodiments, determining the hardware variant to be used to implement the selected feature is based on user input received via the GUI.

In some embodiments, the method includes: performing semantic validation to verify that the IP is capable of interfacing with the signal while following a connection rule; and based on the semantic validation indicating that the IP cannot interface with the signal while following the connection rule, assigning a second IP to interface with the signal, wherein the second IP can interface with the signal while following the connection rule.

In some embodiments of the method, the connection rule specifies that the signal of the hardware variant and a second signal of a second hardware variant are to interface with a same IP.

In some embodiments, the method includes: obtaining a plurality of rules corresponding to a plurality of hardware variants to be used to implement a respective plurality of features of the motor control inverter board; and performing semantic validation to verify that assigning the MCU pin to the signal does not violate any rule of the plurality of rules.

In some embodiments of the method, determining the hardware variant to be used to implement the feature includes: presenting, via the GUI, a plurality of hardware variants that implement the feature; and receiving, via the GUI, selection of the hardware variant from the plurality of hardware variants that implement the feature.

In some embodiments of the method, identifying the signal of the hardware variant to connect to the MCU includes: presenting, via the GUI, a plurality of signals of the hardware variant; and receiving, via the GUI, selection of the signal from the plurality of signals.

In some embodiments of the method, identifying the IP capable of interfacing with the signal includes: accessing a mapping between the signal and IPs capable of interfacing with the signal.

In some embodiments of the method, assigning the MCU pin to interface with the signal is performed automatically.

In some embodiments, the method includes: configuring the motor control inverter board based on the motor control inverter board configuration data structure.

In some embodiments of the method, the MCU pin is non-exclusively assigned to interface with the signal.

In some embodiments of the method, identifying the signal of the hardware variant to connect to the MCU is performed automatically.

In some embodiments, the method includes: determining a layout of the motor control inverter board based on the motor control inverter board configuration data structure.

In various embodiments, a system includes: one or more processors; and one or more memories collectively configured to store instructions executable by the one or more processors to perform actions to: obtain microcontroller unit (MCU) information; present, via a graphical user interface (GUI), a list of features that can be implemented using a motor control inverter board that includes the MCU; receive, via the GUI, selection of a feature of the list of features to be implemented by the motor control inverter board; determine a hardware variant to be used to implement the selected feature; identify a signal of the hardware variant to connect to the MCU; identify, from the MCU information and based on the signal, an intellectual property core (IP) capable of interfacing with the signal; identify, from the MCU information and based on the IP, an MCU pin corresponding to the IP; assign the MCU pin to interface with the signal; and update a motor control inverter board configuration data structure to reflect assigning the MCU pin to interface with the signal.

In some embodiments of the system, one or more processors perform semantic validation by being configured to: obtain a rule specifying a relationship between the signal and a second signal to interface with the MCU; and verify that assigning the IP to interface with the signal does not violate the rule.

In some embodiments of the system, the one or more processors are configured to: configure the motor control inverter board based on the motor control inverter board configuration data structure.

In some embodiments of the system, the second signal is a signal of a second hardware variant that implements a second feature of the motor control inverter board.

In various embodiments, one or more non-transitory computer-readable media collectively store instructions executable by one or more processors to perform actions, the actions comprising: obtaining microcontroller unit (MCU) information; presenting, via a graphical user interface (GUI), a list of features that can be implemented using a motor control inverter board that includes the MCU; receiving, via the GUI, selection of a feature of the list of features to be implemented by the motor control inverter board; determining a hardware variant to be used to implement the selected feature; identifying a signal of the hardware variant to connect to the MCU; identifying, from the MCU information and based on the signal, an intellectual property core (IP) capable of interfacing with the signal; identifying, from the MCU information and based on the IP, an MCU pin corresponding to the IP; assigning the MCU pin to interface with the signal; and updating a motor control inverter board configuration data structure to reflect assigning the MCU pin to interface with the signal.

In some embodiments of the one or more non-transitory computer-readable media, the actions include: configuring the motor control inverter board based on the motor control inverter board configuration data structure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
presenting, via a graphical user interface (GUI), a list of features that can be implemented using a motor control inverter board that includes a microcontroller unit (MCU);
receiving, via the GUI, selection of a feature of the list of features to be implemented by the motor control inverter board;
determining a hardware variant to be used to implement the selected feature;
identifying a signal of the hardware variant to connect to the MCU;
identifying, from the MCU information and based on the signal, an intellectual property core (IP) capable of interfacing with the signal;
identifying, from the MCU information and based on the IP, an MCU pin corresponding to the IP;
assigning the MCU pin to interface with the signal; and
updating a motor control inverter board configuration data structure to reflect assigning the MCU pin to interface with the signal.

2. The method of claim 1, comprising:
performing semantic validation to verify that the IP is capable of interfacing with the signal in accordance with one or more connection rules.

3. The method of claim 1, wherein determining the hardware variant to be used to implement the selected feature is based on user input received via the GUI.

4. The method of claim 1, comprising:
performing semantic validation to verify that the IP is capable of interfacing with the signal while following a connection rule; and
based on the semantic validation indicating that the IP cannot interface with the signal while following the connection rule, assigning a second IP to interface with the signal, wherein the second IP can interface with the signal while following the connection rule.

5. The method of claim 4, wherein the connection rule specifies that the signal of the hardware variant and a second signal of a second hardware variant are to interface with a same IP.

6. The method of claim 1, comprising:
obtaining a plurality of rules corresponding to a plurality of hardware variants to be used to implement a respective plurality of features of the motor control inverter board; and
performing semantic validation to verify that assigning the MCU pin to the signal does not violate any rule of the plurality of rules.

7. The method of claim 1, wherein determining the hardware variant to be used to implement the feature includes:
presenting, via the GUI, a plurality of hardware variants that implement the feature; and
receiving, via the GUI, selection of the hardware variant from the plurality of hardware variants that implement the feature.

8. The method of claim 1, wherein identifying the signal of the hardware variant to connect to the MCU includes:
presenting, via the GUI, a plurality of signals of the hardware variant; and
receiving, via the GUI, selection of the signal from the plurality of signals.

9. The method of claim 1, wherein identifying the IP capable of interfacing with the signal includes:
accessing a mapping between the signal and IPs capable of interfacing with the signal.

10. The method of claim 1, wherein assigning the MCU pin to interface with the signal is performed automatically.

11. The method of claim 1, comprising:
configuring the motor control inverter board based on the motor control inverter board configuration data structure.

12. The method of claim 1, wherein the MCU pin is non-exclusively assigned to interface with the signal.

13. The method of claim 1, wherein identifying the signal of the hardware variant to connect to the MCU is performed automatically.

14. The method of claim 1, comprising:
determining a layout of the motor control inverter board based on the motor control inverter board configuration data structure.

15. A system comprising:
one or more processors; and
one or more memories collectively configured to store instructions executable by the one or more processors to perform actions to:
obtain microcontroller unit (MCU) information;
present, via a graphical user interface (GUI), a list of features that can be implemented using a motor control inverter board that includes the MCU;
receive, via the GUI, selection of a feature of the list of features to be implemented by the motor control inverter board;
determine a hardware variant to be used to implement the selected feature;
identify a signal of the hardware variant to connect to the MCU;
identify, from the MCU information and based on the signal, an intellectual property core (IP) capable of interfacing with the signal;
identify, from the MCU information and based on the IP, an MCU pin corresponding to the IP;
assign the MCU pin to interface with the signal; and
update a motor control inverter board configuration data structure to reflect assigning the MCU pin to interface with the signal.

16. The system of claim 15, wherein the one or more processors perform semantic validation by being configured to:
obtain a rule specifying a relationship between the signal and a second signal to interface with the MCU; and
verify that assigning the IP to interface with the signal does not violate the rule.

17. The system of claim 16, wherein the one or more processors are configured to:
configure the motor control inverter board based on the motor control inverter board configuration data structure.

18. The system of claim 16, wherein the second signal is a signal of a second hardware variant that implements a second feature of the motor control inverter board.

19. One or more non-transitory computer-readable media collectively storing instructions executable by one or more processors to perform actions, the actions comprising:
obtaining microcontroller unit (MCU) information;
presenting, via a graphical user interface (GUI), a list of features that can be implemented using a motor control inverter board that includes the MCU;
receiving, via the GUI, selection of a feature of the list of features to be implemented by the motor control inverter board;
determining a hardware variant to be used to implement the selected feature;
identifying a signal of the hardware variant to connect to the MCU;
identifying, from the MCU information and based on the signal, an intellectual property core (IP) capable of interfacing with the signal;
identifying, from the MCU information and based on the IP, an MCU pin corresponding to the IP;
assigning the MCU pin to interface with the signal; and
updating a motor control inverter board configuration data structure to reflect assigning the MCU pin to interface with the signal.

20. The one or more non-transitory computer-readable media of claim 19, the actions comprising:
configuring the motor control inverter board based on the motor control inverter board configuration data structure.
